(19) United States
(12) Patent Application Publication
(10) Pub. No.: US 2006/0182197 A1
(43) Pub. Date: Aug. 17, 2006

(54) Blind RF carrier feedthrough suppression in a transmitter

(75) Inventors: Nihal J. Godambe, Palatine, IL (US); Daniel L. Kaczman, Gurnee, IL (US)

Correspondence Address: BRINKS, HOFER, GILSON & LIONE;FREESCALE, P.O. BOX 10395, CHICAGO, IL, 60610, US

(73) Assignee: FREESCALE SEMICONDUCTOR, INC.

(21) Appl. No.: 11/057,743

(22) Filed: Feb. 14, 2005

(51) Int. Cl. H04L 25/49; H04B 1/707

(52) U.S. Cl. 375/297; 375/146

(57) ABSTRACT

A transmitter is provided that corrects for both static and dynamic offsets to minimize carrier feedthrough. A feedback loop permits correction to be performed during normal operation of the transmitter, rather than during a calibration sequence in which the inputs are zeroed. The transmitter includes an adder that subtracts a correction signal from an input signal to produce a corrected signal. A filter filters the corrected signal and a modulator modulates the filtered signal to produce an RF signal. The feedback loop includes a mixer that converts the RF signal to baseband, an A/D converter that converts the baseband signal to a digital signal, which is provided to an FFT, a matched filter that filters the signal from the FFT, a Maximum Seeking Frequency Estimator that determines the maximum signal, and a gain that compensates for the feedback loop and produces the correction signal.

### FIELD

The present application relates to a transmitter. More specifically, the present application relates to a transmitter in which carrier feedthrough is suppressed.

### BACKGROUND

The variety of portable electronic devices as well as the usage of such devices has dramatically increased in recent years. This is especially true of mobile handsets, which are presently used by a large proportion of the populations in the United States, Europe, and Japan, for example. Mobile handsets contain modulators that enable wireless transmissions by permitting complex modulation formats that support modem, high-data-rate wireless communications, such as wideband code-division multiple access (WCDMA).

Electronic devices use different modulation schemes for communication. One such scheme is Quadrature Phase Shift Keying (QPSK) modulation. In QPSK, data to be transmitted is separated into two signals in the integrated circuit that are phase shifted by 90°, an in-phase (I) channel signal and quadrature-phase (Q) channel signal, and then recombined into a single symbol. The I-channel data is modulated by applying a sine wave of a particular frequency to the I-channel data, and Q-channel data is modulated by applying a cosine wave of the same frequency to the Q-channel data. The modulated, combined signal containing both the I-channel and Q-channel data is up-converted into a higher, radio frequency (RF) signal, transmitted to a desired location where the RF signal is received, and down-converted to the original signal in a receiver.

In the past, the modulated signal to be transmitted was converted to the RF signal through an intermediate stage - by first up-converting the signal to an intermediate frequency, filtering the intermediate frequency signal and then further up-converting the signal to the desired RF signal. The transmitted RF signal, once received, was down-converted through a similar intermediate stage to the original frequency. However, using an intermediate frequency stage requires a large number of components, and is relatively complex.

Recently, integration of transmitters and receivers has become advanced enough to create transmitters and receivers that directly convert the signal to/from an RF signal. Transmitters using this architecture are called direct launch transmitters. While this reduces the number of components, direct launch architectures engender other problems. For example, some applications require a high gain control range. Direct launch architectures suffer from DC offsets of up to a few millivolts on the I-channel data and Q-channel data, each of which has an output of around 1V. These offsets give rise to carrier leakage and thus decrease the range over which the gain can be controlled. In next generation systems, the range over which the gain is required to be controlled is large. For example, for transmitters operating under third generation WCDMA specifications, the control range is required to be at least 100 dB. In code-division multiple access (CDMA), every channel uses the full available spectrum rather than assigning a specific frequency to each user. Individual conversations are encoded with a pseudo-random digital sequence. WCDMA supports data rates faster than CDMA, reaching speeds of up to 2 Mbps for voice, video, data and image transmission. To achieve the gain control range for WCDMA, acceptable offset levels on the I-channel data and Q-channel should be less than a millivolt (0.001 V).

### BRIEF DESCRIPTION OF THE DRAWINGS

FIG. 1 shows a transmitter signal containing carrier feedthrough.

FIG. 2 shows a graph of output power vs. gain with and without carrier feedthrough.

FIG. 3 is a prior art transmitter containing a feedback loop.

FIG. 4 is a transmitter of a first embodiment.

FIG. 5 is a transmitter of a second embodiment.

FIG. 6 is a method of correction in one embodiment.

FIG. 7 is a transmitter signal without correction applied.

FIG. 8 is a transmitter signal with correction applied according to the embodiment shown in either FIGS. 4 or 5.

### DETAILED DESCRIPTION OF THE EMBODIMENTS

DC offset on one or more channels in a transmitter originates essentially from two static sources, which are independent of the input signal to be transmitted, and one dynamic source, which is a function of the level of the input signal to be transmitted. The dynamic source is second order distortion caused by the modulation and second-order non-linearities in the modulator. As each of the I and Q channel signals are produced along a different path, one source of the DC offset is mismatch between the supposedly identical components used to produce the signals. The components differ due to, for example, process variations during fabrication of the integrated circuit forming the transmitter.

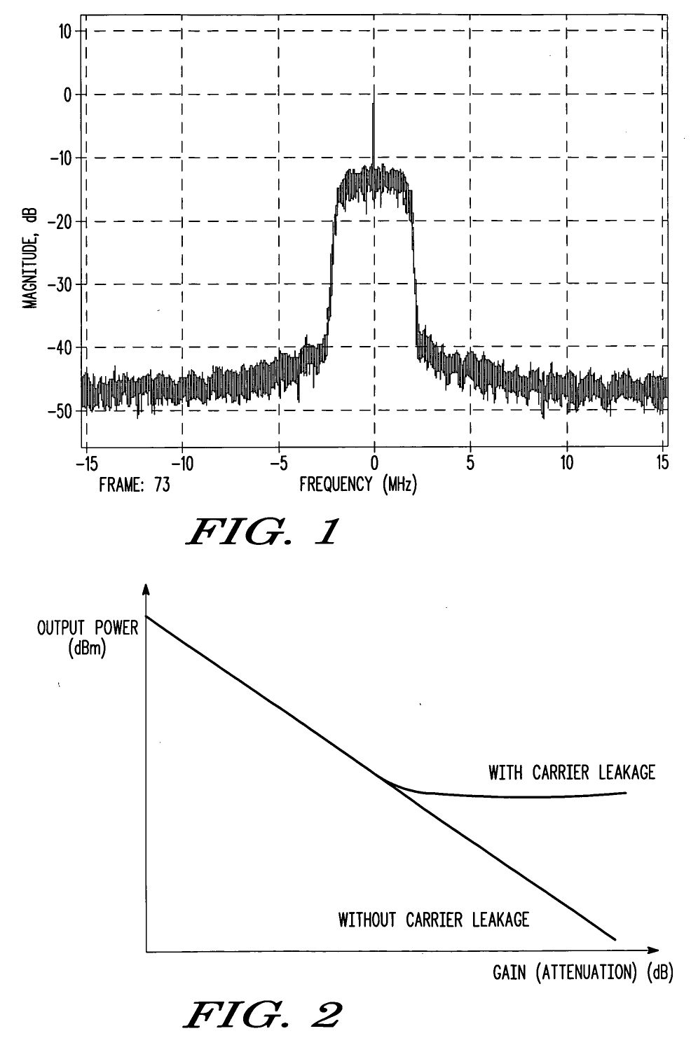

The DC offsets above give rise to carrier feedthrough (or carrier leakage) of the local oscillator signal during regular operation. This carrier signal leaks through to the output. An example of carrier feedthrough (CFT) is shown in FIG. 1 (at DC for convenience), in which a signal of about 5 MHz width centered around DC contains a CFT spike at DC. As shown in FIG. 2, without CFT, the output power decreases linearly with a controlled decrease in gain (i.e. attenuation). When CFT exists, as the gain is decreased, the output power eventually levels out due to the carrier signal that leaks through to the output.

The CFT performance of the modulator affects the transmitter in two ways: it affects the overall EVM (Error Vector Magnitude) of the transmitter line-up and, as above, it compromises the gain control range. The EVM is a measure of the difference between the ideal waveform and the measured waveform. The overall EVM is affected as the carrier peaks out of the modulated transmitter spectrum. The EVM is a system specification that must be met by transmitter handsets under normal operation in which the input signals are not grounded. The gain control range is compromised as the carrier leakage sets the lowest signal level achievable.

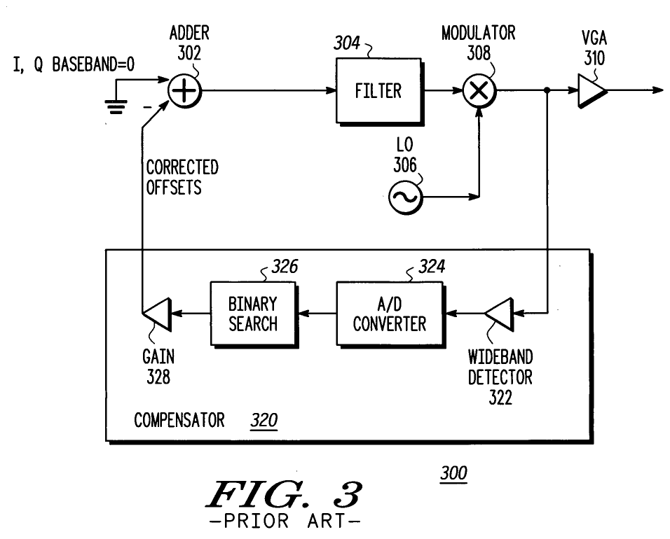

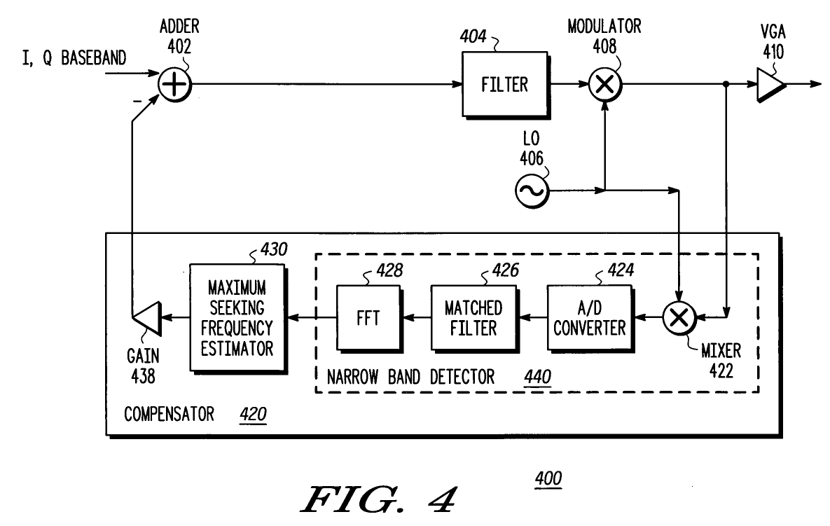

To reduce the DC offsets which cause CFT, other methods require a dedicated calibration sequence when no modulation is present and do not work with modulation present, or when the temperature of the circuitry changes. FIG. 3 illustrates a known method of carrier suppression. As shown, the suppression circuit 300 of FIG. 3 includes an adder 302 in which a digital signal and a digital control signal are combined, a filter 304 that filters the signal from the adder 302, a modulator 308 that modulates the filtered signal into an analog signal using a carrier signal from a local oscillator 306 at, say 2 GHz, and a variable gain 310 that adjusts the gain of the modulated signal for transmission. The modulated signal is also fed along a feedback path through a compensator 320. In the compensator 320, the modulated signal is detected using a wideband detector 322 that detects the energy of the entire spectrum fed to it, including the carrier feedthrough signal at 2 GHz. The detected signal is converted into a digital signal by an analog-to-digital (A/D) converter 324, the digital signal is passed through a binary search 326, supplied to a gain 328 and the amplified signal is subtracted from the original digital signal by the adder 302. The gain 328 adjusts the signal strength for losses (or gains) encountered by the signal in passing through feedback path, i.e. for the effect of a feedback loop between the RF signal and the input signal.

In the method using the arrangement shown in FIG. 3, the carrier is detected at the output of the modulator 308 and then the I-Q channel offsets are adjusted in the opposite direction to null. During calibration the I-Q inputs are shorted and the residual carrier power is detected by the wideband power detector 322. A binary search algorithm is run at the binary search 326. The binary search algorithm is applied to the I-Q channel offsets sequentially to reduce the detected carrier leakage. The binary search algorithm essentially increases the offset fed back to the input at the adder 302 and determines whether the carrier leakage power increases or decreases for each of the I-Q channels. If the carrier leakage power decreases, the binary search algorithm continues to increase the fed-back offset until the residual carrier is nulled (i.e. reduced to zero). If the carrier leakage power increases, the binary search algorithm instead decreases the fed-back offset until the residual carrier is nulled.

However, this technique is applied when the I-Q channel inputs are grounded, rather than during normal operation with modulation present, as the wideband detector detects signals of all frequencies. Distortions and corresponding DC offsets that appear during normal operation do not appear when the I-Q channels are grounded. In addition, as the feedback path is disconnected during normal operation, the offsets in the normal transmission mode may be different from the offsets corrected for in the calibration mode. Further, only the offsets caused by the static sources are corrected. In addition, this is a relatively long process as both I-Q channels are individually adjusted in one or two directions until each offset is zeroed.

An apparatus and method are provided in which carrier suppression, as well as suppression of offsets caused by other static and dynamic sources, is performed during normal operation. Normal operation is operation with transmit modulation present and with or without temperature changes. For normal operation, the input signals are not grounded. The suppression may be run ‘blind,’ that is without a calibration mode in which the I-Q channels are grounded. The transmitter may use standard components used in transmitters and/or receivers.

In one embodiment the transmitter contains an adder, a local oscillator, a modulator, and a feedback loop. The adder subtracts a correction signal from a non-grounded input signal to produce a corrected signal. The local oscillator produces a local oscillation signal, which is used by the modulator to modulate the correction signal to produce a radio frequency (RF) signal. The feedback loop receives the RF signal and provides the correction signal to the adder. Other components may be present in the transmitter.

The feedback loop may contain a mixer, an analog-to-digital (A/D) converter, a matched filter, a Fast Fourier Transform (FFT), a Maximum Seeking Frequency Estimator, and a gain. The mixer converts the RF signal to a down-converted signal, which the A/D converter digitizes and supplies to the matched filter. The matched filter filters the signal and supplies it to the FFT, which in turn supplies the Fourier-transformed signal to the Maximum Seeking Frequency Estimator. The Maximum Seeking Frequency Estimator then determines a maximum of the signal from the FFT. The gain receives the signal from the Maximum Seeking Frequency Estimator and produces the correction signal.

In another embodiment, the transmitter includes a transmit path operable to output an RF signal in response to input baseband signals and a means for providing a correction signal to the transmit path while the transmitter is transmitting output signals. In this case, the transmitter may or may not have a separate calibration mode to correct offsets in the output signals caused by static sources. The providing means may correct for offsets caused by both static and dynamic sources.

In another embodiment, a method of correcting for offsets in output signals of a transmitter includes: producing a radio frequency (RF) signal from a corrected signal; generating a correction signal from the RF signal; subtracting the correction signal from a non-grounded input signal used to generate the RF signal; and transmitting the RF signal.

In another embodiment, a transmitter contains a direct launch transmitter, a feedback path, and an adder. The direct launch transmitter is operable to generate an RF signal in response to a non-grounded input baseband signal. The feedback path is responsive to the RF signal and contains a down-converter that down-converts the RF signal. The adder is operable to add an output of the feedback path to the input baseband signal.

These and other embodiments are described in more detail below.

FIG. 4 illustrates one embodiment of a transmitter containing a compensator. The transmitter 400 includes an adder 402 in which a baseband signal and a control signal are combined. The baseband signal can be, for example, an I or Q channel signal used in QPSK modulation. The transmitter 400 also includes a filter 404 that filters the baseband signal from the adder 402, a modulator 408 that up-converts the filtered baseband signal to the radio frequency (RF) band using a carrier signal from a local oscillator (LO) 406, and a variable gain 410 that adjusts the gain of the modulated signal for transmission. The LO 406 operates at 2 GHz, for example, and thus the filtered signal is up-converted to about 2 GHz. The radio frequency band is between about 800 MHz and about 2 GHz, but in other embodiments may operate in the 5-6 GHz range or other frequencies.

The modulated signal is also fed along a feedback path through a compensator 420 that contains a narrow band detector 440. In the narrow band detector 440, the modulated signal is down-converted in a mixer 422 using the LO 406 from the RF signal so that the down-converted signal essentially mirrors the original filtered baseband signal entering the modulator 408. The down-converted signal is converted into a digital signal by an analog-to-digital (A/D) converter 424. The digital signal is filtered using a matched filter 426, which has the same characteristics as the filter 404. For example, the matched filter 426, like the filter 404, may be a lowpass filter with a pass band of about −5 MHz to 5 MHz. The matched filter 426 maximizes the energy of the input signal similar to the manner in which a matched filter in a receiver maximizes energy to the receiver. The digital signal then passes through a Fast Fourier Transform (FFT) 428, which detects the power in the carrier. The compensator 420 also contains a Maximum Seeking Frequency Estimator 430 to which the signal from the FFT 428 in the narrow band detector 440 is supplied. The output from the Maximum Seeking Frequency Estimator 430 is supplied to a gain 428 that adjusts for losses (or gains) of the signal for passing through the compensator 420. Gain may be introduced by the FFT 428 and/or the matched filter 426. Accordingly, the gain 428 may reduce the signal from the Maximum Seeking Frequency Estimator 430 rather than increase it. The gain 428 adjusts the signal strength from the Maximum Seeking Frequency Estimator 430 for the effect of a feedback loop between the RF signal and the input signal. The signal from the gain 428 is subtracted from the original digital signal by the adder 402.

Because the mixer 422 does not have to meet the stringent (e.g. cellular) requirements of a modulator for transmission of the signal, the mixer 422 can be relatively simple compared with the modulator 408. The output of the signal from the mixer 422 is also at baseband, as shown in the figures in the examples, around 5 MHz.

In addition, although the modulated signal is shown as being down-converted using the same LO as that used to up-convert the filtered signal, a separate local oscillator having the same frequency may be used. Similarly, although the inputs to the transmitter 400 are shown as I and Q channel signals at baseband, any modulation signals at baseband may be used. Also, only one signal (for example, one of the I channel or Q channel signals) is compensated in the arrangement shown in FIG. 4. A different branch of the transmitter containing similar components may be present if an additional signal is to be compensated (e.g., the other of the I channel or Q channel signal). If multiple branches are present, the number of components may be minimized. For example, the local oscillator may provide oscillation signals for more than one branch. Some of the various components in multiple branches of the transmitter may be integrated to ensure comparable characteristics between the similar components.

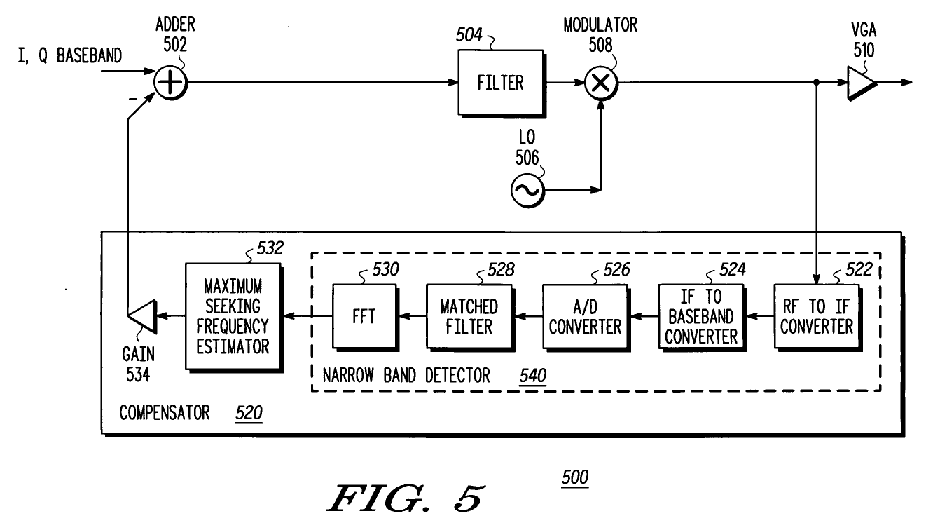

FIG. 5 illustrates another embodiment of a transmitter containing a compensator. As the embodiment in FIG. 4, FIG. 5 shows only one branch of the transmitter. Some or all of the components may be integrated. The transmitter 500 of FIG. 5 is similar to the arrangement of FIG. 4. The transmitter 500 includes an adder 502 in which a baseband signal and a control signal are combined, a filter 504 that filters the baseband signal from the mixer 502, a modulator 508 that up-converts the filtered signal from baseband to the RF band using a carrier signal from a local oscillator (LO) 506, and a variable gain 510 that adjusts the gain of the modulated signal for transmission. The LO 506 operates at 2 GHz, for example, and thus the filtered signal is up-converted to about 2 GHz.

The modulated signal is also fed along a feedback path through a compensator 520 that contains a narrow band detector 540. In the narrow band detector 540, the modulated signal is down-converted from the RF band to an intermediate frequency (IF signal) in an RF to IF converter 522. The IF signal lies in a frequency range between the RF band and the baseband. For example, if the RF band is about 2 GHz, the IF band may be several hundred MHz. The IF signal is then down-converted back to the original baseband signal using an IF to baseband converter 524. As above, as the rigorous requirements for transmission modulation do not have to be met in the feedback loop, known converters used in receivers may be used for each of the RF to IF converter 522 and IF to baseband converter 524.

The down-converted baseband signal is converted into a digital signal by an analog-to-digital (A/D) converter 526. The digital signal is filtered using a matched filter 528, which has the same characteristics as the filter 504. As above, the matched filter 528, like the filter 504, may be a lowpass filter with a pass band of about −5 MHz to 5 MHz. The matched filter 526 maximizes the energy of the input signal similar to the manner in which a matched filter in a receiver maximizes energy to the receiver. The digital signal then passes through a Fast Fourier Transform (FFT) 530, which detects the power in the carrier. The compensator 520 also contains a Maximum Seeking Frequency Estimator 532 to which the signal from the FFT 530 in the narrow band detector 540 is supplied. The output from the Maximum Seeking Frequency Estimator 532 is supplied to a Gain 534 that adjusts for losses (or gains) of the signal caused by passing through the feedback loop. Gain may be introduced by the FFT 530 and/or the matched filter 526. Accordingly, the Gain 534 may reduce the signal from the Maximum Seeking Frequency Estimator 532 rather than increase it. The amplified signal is subtracted from the original digital signal by the adder 502.

Unlike the embodiment of FIG. 4, the signal from the local oscillator 406 is not applied to a mixer to down-convert the RF signal from the modulator 408 directly to baseband. In one embodiment, one or more separate local oscillators (not shown) are used to down-convert the RF signal to the IF signal and then to further convert the IF signal to baseband. As in the embodiment of FIG. 4, however, although the inputs to the transmitter 500 are shown as I and Q channel signals at baseband, any modulation signals at baseband may be used.

In either embodiment shown in FIG. 4 or FIG. 5, the compensator compensates for the DC offsets at the I-Q inputs in the presence of a modulating I or Q channel signal. Thus, calibration can be performed blind, without any training or calibration input signals, during normal operation. Normal operation is operation in which the transmitter receives non-grounded I and Q channel signals, which are transmitted after being compensated.

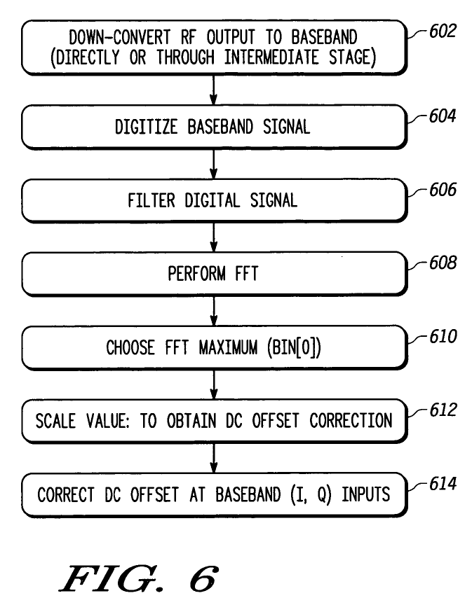

FIG. 6 illustrates the method through which the offsets are corrected. In FIG. 6, the output of the modulator is down-converted to the baseband 602. The down-conversion can be performed using a direct conversion receiver as shown in FIG. 4 or by down-converting to an intermediate frequency (IF) signal and sampling the IF signal down to baseband, as shown in FIG. 5. The baseband signal is digitized 604 using an A/D converter. The digitized signal is then lowpass filtered 606 using a matched filter. A Fourier transform of the matched filter output is then taken 608 using an FFT. The carrier power 610 is, in one embodiment, found in the 0 bin of the FFT (i.e. at DC), which reflects the error signal. The width of each bin in the FFT may be set as desired, for example a few kHz. In this example, bin 0 may represent the amplitude of signals in the range of −1 KHz to 1 KHz, bin 1 may represent the amplitude of signals in the range of 1 KHz to 3 KHz, etc . . . The FFT value represents the carrier power. This value is scaled by a factor 612 that is a function of the input DC level and the losses (or gain) incurred through the entire feedback path and then subtracted from the I-Q inputs as a DC correction 614.

In other embodiments, rather than down-convert the RF signal to DC, the feedback loop may down-convert the RF signal to a relatively low frequency. This relatively low frequency may be less than about 1 MHz, for example, 200 kHz. In this case, the characteristics of the matched filter may be different from that of the filter and the FFT may or may not select bin 0 (DC) as the bin containing the maximum signal amplitude, depending on the width of the bin and the frequency to which the RF signal is converted. Accordingly, as used herein, down-converting the RF signal to baseband includes down-converting the RF signal both to DC or to a relatively low frequency. The signal may be down-converted directly to the relatively low frequency or down-converted via an intermediate frequency, as before.

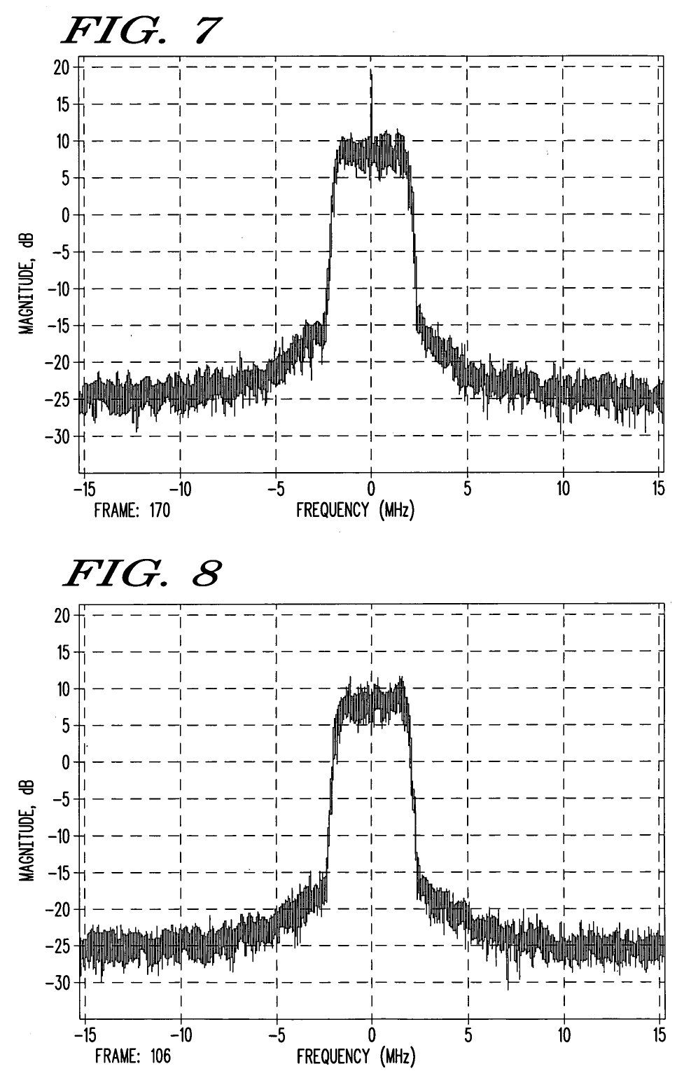

FIGS. 7 and 8 show graphs of a transmitter spectrum with and without correction applied. Each spectrum has been shifted to DC for convenience. In FIG. 7, as in FIG. 1, a spike appears at around DC. The spike is primarily due to carrier feedthrough. With no correction applied, the carrier feedthrough is −26 dBc (i.e. carrier is 27 dB below the RF output signal), the offsets are 60 mV, and the total transmitter EVM is 8.6%. On the other hand, with correction applied, the carrier feedthrough decreases to −46 dBc, the offsets are 2 mV, and the total transmitter EVM is 6.68%. The EVM required for WCDMA is 8%, thus without correction the transmitter is unacceptable while with correction the transmitter is acceptable. This can be compared with the corrector of FIG. 3, in which the carrier feedthrough degraded from −54 dBc during the calibration mode to −35 dBc in the normal mode, i.e. with modulation applied. The correction is robust against phase errors of about 2 degrees between the I and Q channel signals, that is although the I and Q channel signals are supposed to be 90 degrees out of phase, a deviation of up to about 2 degrees can be tolerated. In addition, the correction is able to compensate for a gain imbalance between the I and Q channel of up to about 0.25 dB.

It is therefore intended that the foregoing detailed description be regarded as illustrative rather than limiting, and that it be understood that it is the following claims, including all equivalents, that are intended to define the spirit and scope of this invention. Nor is anything in the foregoing description intended to disavow scope of the invention as claimed or any equivalents thereof.

We claim:

1. A transmitter comprising:
an adder that subtracts a correction signal from a non-grounded input signal to produce a corrected signal;
an oscillator that produces an oscillation signal;
a modulator that modulates the corrected signal with the oscillation signal from the oscillator to produce a radio frequency (RF) signal;
a feedback loop that receives the RF signal and provides the correction signal to the adder.

2. The transmitter of claim 1, wherein the feedback loop comprises a mixer that converts the RF signal to a down-converted signal.

3. The transmitter of claim 2, wherein the mixer down-converts the RF signal to baseband.

4. The transmitter of claim 3, wherein the mixer mixes the oscillation signal from the local oscillator to down-convert the RF signal directly to baseband.

5. The transmitter of claim 3, wherein the mixer down-converts the RF signal by down-converting to an intermediate frequency and sampling the intermediate frequency down to the baseband.

6. The transmitter of claim 1, wherein the feedback loop is present when the transmitter is transmitting.

7. The transmitter of claim 1, wherein the transmitter transmits signals under wideband code-division multiple access standards, the transmitter uses Quadrature Phase Shift Keying modulation, and the input signal is an I or Q channel signal.

8. The transmitter of claim 1, further comprising a filter disposed between the adder and the modulator and a variable gain amplifier that amplifies the RF signal.

9. The transmitter of claim 1, wherein the correction signal compensates for a DC offset.

10. The transmitter of claim 1, wherein the feedback loop comprises:
an analog-to-digital converter that digitizes the down-converted signal;
a filter that filters the digital signal;
a Fast Fourier Transform (FFT) that receives the filtered signal from the filter;
a Maximum Seeking Frequency Estimator that determines a maximum of the signal from the FFT; and
a gain that receives the signal from the Maximum Seeking Frequency Estimator and produces the correction signal.

11. The transmitter of claim 1, wherein the transmitter is a direct launch transmitter.

12. A method of correcting for offsets in output signals of a transmitter, the method comprising:
producing a radio frequency (RF) signal from a corrected signal;
generating a correction signal from the RF signal;
subtracting the correction signal from a non-grounded input signal to generate the corrected signal; and
transmitting the RF signal.

13. The method of claim 12, wherein the subtracting comprises correcting for offsets caused by both the static and dynamic sources in a transmission mode and without a separate calibration mode.

14. The method of claim 12, wherein generating the correction signal comprises converting the RF signal to a down-converted signal.

15. The method of claim 14, wherein converting the RF signal to the down-converted signal comprises down-converting the RF signal directly to baseband.

16. The method of claim 15, further comprising generating an oscillation signal from a single oscillator that generates the RF signal from the corrected signal and down-converts the RF signal to baseband.

17. The method of claim 14, wherein converting the RF signal to the down-converted signal comprises down-converting the RF signal to an intermediate frequency and then further down-converting the intermediate frequency to a lower frequency signal.

18. The method of claim 14, wherein generating the correction signal comprises:
digitizing the down-converted signal;
filtering the digital signal;
effecting a Fourier transform on the filtered signal using a Fast Fourier Transform (FFT);
determining a maximum of the Fourier-transformed signal; and
adjusting a signal strength of the determined signal for the effect of a feedback loop between the RF signal and the input signal.

19. A transmitter comprising:
a direct launch transmitter operable to generate an RF signal in response to an input baseband signal;
a feedback path responsive to the RF signal, the feedback path containing a down-converter that down-converts the RF signal; and
an adder operable to add an output of the feedback path to the input baseband signal.

20. The transmitter of claim 19, wherein the down converter down-converts the RF signal directly to baseband.

21. The transmitter of claim 18, wherein the feedback loop is present when the transmitter is transmitting.

22. The transmitter of claim 18, wherein the correction signal compensates for a DC offset.
